(19) United States
(12) Patent Application Publication
(10) Pub. No.: US 2010/0040990 A1
(43) Pub. Date: Feb. 18, 2010

(54) Precombustion chamber for canned heat products

(76) Inventor: DENNIS DUANE PAUL, Atlantis, FL (US)

Correspondence Address: DENNIS DUANE PAUL, 572 So. Countryclub Drive, Atlantis, FL, 33462, US

(21) Appl. No.: 12/228,516

(22) Filed: Aug. 14, 2008

(51) Int. Cl. F23D 3/18; F23D 3/40; A47J 36/30

(52) U.S. Cl. 431/323; 126/45; 126/50; 431/320

(57) ABSTRACT

This invention provides an improved chamber within the can of a canned heat product that allows more complete combustion due to a better mixing of air and gasified fuel which eminates from fuel on the surface of a fibrous fill. This improved mixing is the result of pulling cold outside air into the outer annulus of the combustion chamber where mixing occurs prior to ignition and also cools the fuel holding fiber as well as providing a steady height point of maximum temperature due to the combustion.

### FIELD OF INVENTION

This invention provides an improvement in the combustion of fuel in canned heat products.

### BACKGROUND AND PRIOR ART

Canned Heat products, as represented by trademarked products such as STERNO, have been a relatively low technology area of food service. Although widely used in chafing dishes and other food service heaters, in camping as a convenient stove or heating source, and in emergency kits, the can of fuel is far from optimized for burn efficiency or safety. The major sales factor is the burn time, largely fixed by total fluid content in the can.

The full can of fuel is the standard for canned heat products. The best version of the canned heat consists of a fiber fill (fiberglass or rock wool) immersed in a flammable or burnable fluid. While gels and liquid are used, there are good commercial reasons that these are losing popularity. A wick is often inserted into the fiber fill to aid in initiating the flame and in some versions there is a pad or other surface gasifier to aid in the transport between the liquid front at the can top and the flame front above the can.

As the can burns, the fiber filled cans retain a top gasification and flame front above the can while the liquid level in cans drops and this slows total combustion as the liquid is gasified less effectively due to the receding liquid level.

In examining the air flow in the normal fiber filled canned heat product, it is noted that the central plume of gas is from the gasification of combustibles at the surface of the fiber and the air flow from ambient essentially then flows up and inward forming an annular ring of air around the upwelling gas core. This flow occurs at relatively low Reynolds numbers ensuring that the gas/air front is a discrete ring and that extreme mixing of turbulent flow probably is absent until within the flame front. This results in a wide area of flame front and causes low combustion efficiency since the mix provides too much air in some zones and too little in others. There is a need for better mixing within a canned heat product flame front.

Another problem can hinder the effectiveness of a canned heat flame. The fiber, being near and highly heated by the flame front can be glazed. The glaze, created by a softening or melting of the fiber, lowers the fluid flow and thus, while probably extending the burn time, results in a diminishing flame intensity lowering the effective use time for the product. There is a need to cool the fiber surfaces to prevent glazing.

A final problem in the canned heat product is the fact that, while total heat is steady, the flame front varies in height as the glazing and the mixing change over time thus the “sweet spot” or optimum temperature area within the flame front varies in height over time thus causing either lowered heat production at a fixed point from the top of the can (such as a pan). There is a need for a canned heat product that has a constant height of the maximum temperature spot in relation to the can top.

### DESCRIPTION OF THE INVENTION

The present invention examines the fuel combustion efficiency in a canned heat product and, by modification of the area and gas flow prior to actual combustion, provides a better burning and hotter flame tip from a standard heat can with only a small detriment to total burn time.

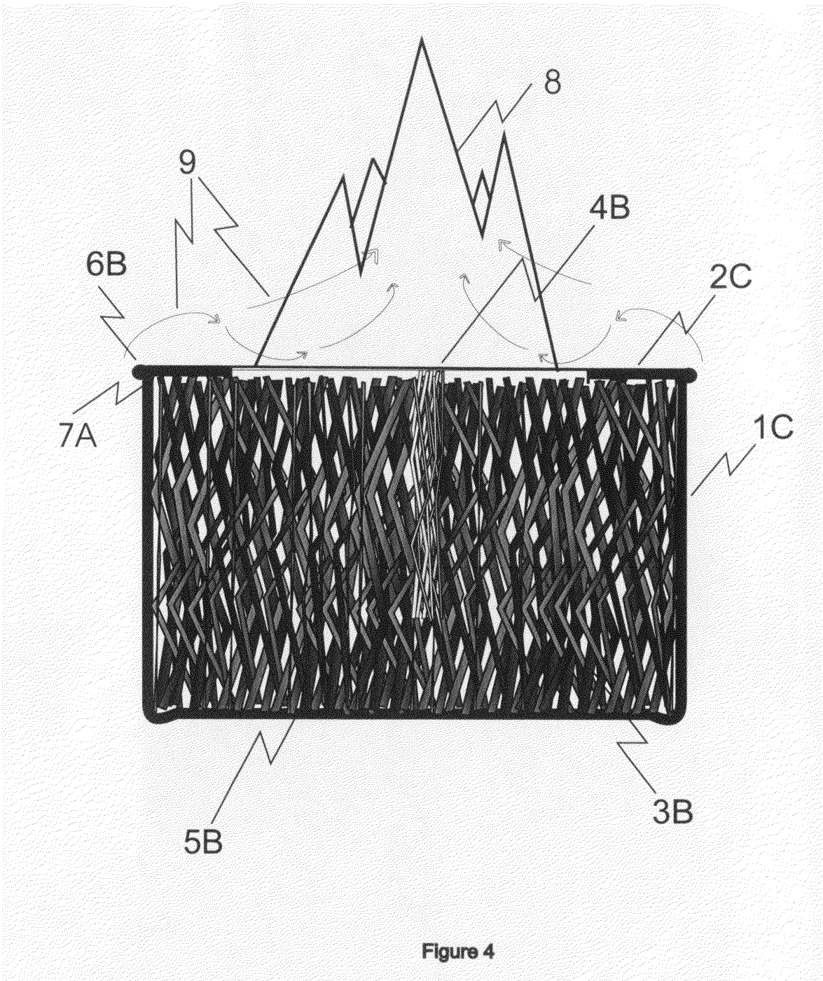

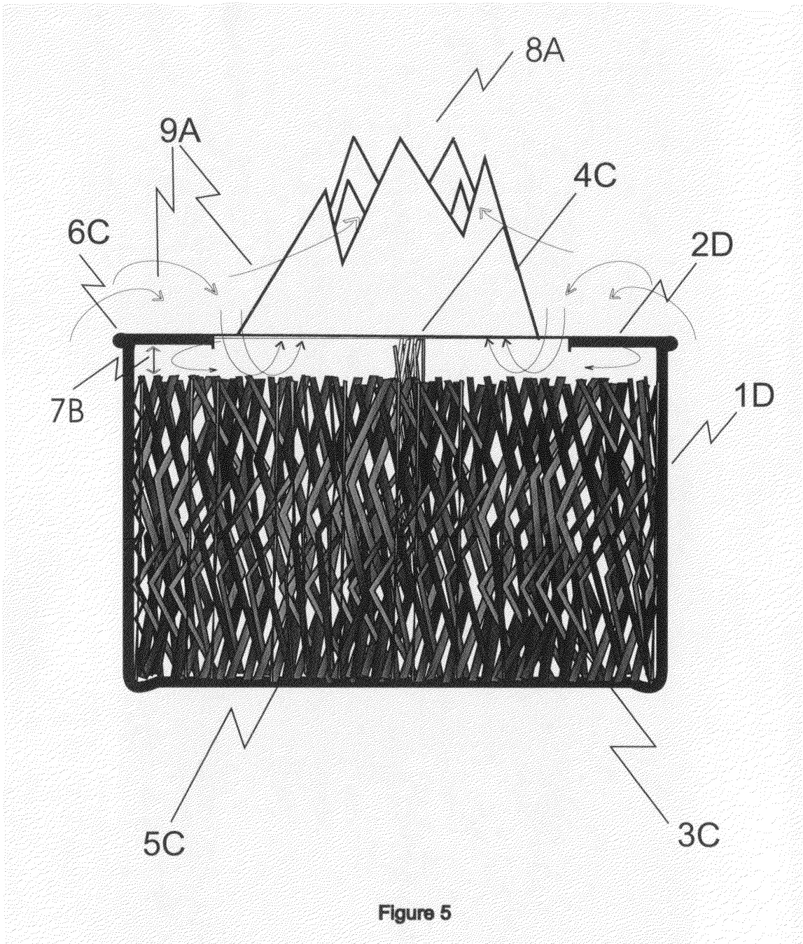

The present invention creates an in can precombustion chamber defined by the dimension 7 in the figures where air is induced to flow into the precombustion chamber by the velocity of the outflowing gas from the central zone of the exposed surface of the can as shown by the arrows 9A in FIG. 5 and this gas outflow induces air flow into the can along the cooler (less gasification of combustibles) edge areas of the can and along the fiber then mixes with the central column of outgassing combustibles to provide a better mix and thus a better combustion. Since this action continues throughout the burn the mixing also helps stabilize the “sweet spot” of maximum temperature and results in a flatter better burning flame front shown as 8A and comared to the flame front 8 in FIG. 4. The introduction of air flow into the precombustion chamber also cools the gasification slightly and cools the outgassing column thus reducing the glazing of the surface of the fiber.

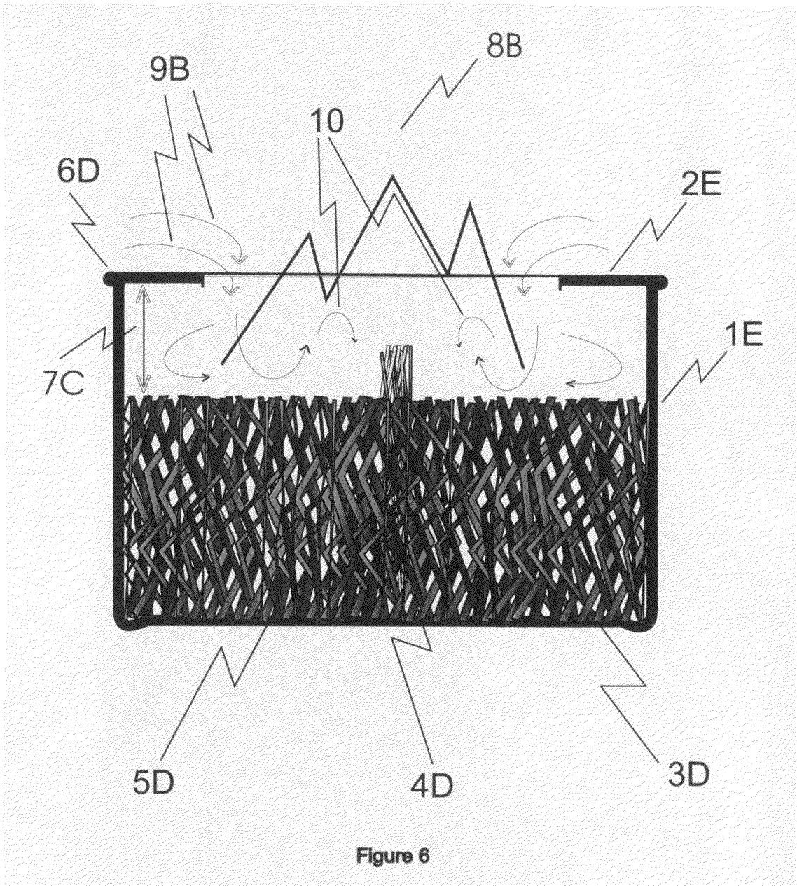

The precombustion chamber is critical in dimensions. While it would be expected that ever larger (in depth) chambers would be an advantage in practical use it is found that there is a balance that limits the depth of the chamber to less than ¾ inch from the top of the can and ideally to a distance of ½ inch from the top of the can (the dimensions 7 in the drawings). It is theorized that the increasing depth of the precombustion chamber lowers the heating of the fiber top as the precombustion chamber depth is increased lowering the effectiveness and total heat production per time unit. This is shown in FIG. 6 where the flame front 8B is nearly sucked into the can.

The precombustion chamber can also be too shallow. At less than ¼ inch depth the air flow mixing is grossly reduced and the flame acts as in a normal canned heat product as in FIG. 4. In FIG. 9, the air is not pulled into the can in an appreciable manner or amount thus the mixing is reduced thus providing a candle like flame front 8. This theorized reduction in mixing would result from the induced air flow reduction until as the top of the fiber closes on the top of the can opening the air flow is again reduced to a relatively laminar annulus surrounding the combustible central core flow.

The present invention provides for a can with fiber fill which has the fiber fill cut ½ inch less than the height of the can, is then inserted into the can which is then topped with a can top with at least one opening and filled with a combustible fluid. The fill is pressed in production toward the bottom of the can and thus a ½ inch space is formed at the top of the can. An igniter wick is generally inserted into the center of the can but this is not essential to the effectiveness of this invention.

### DRAWINGS

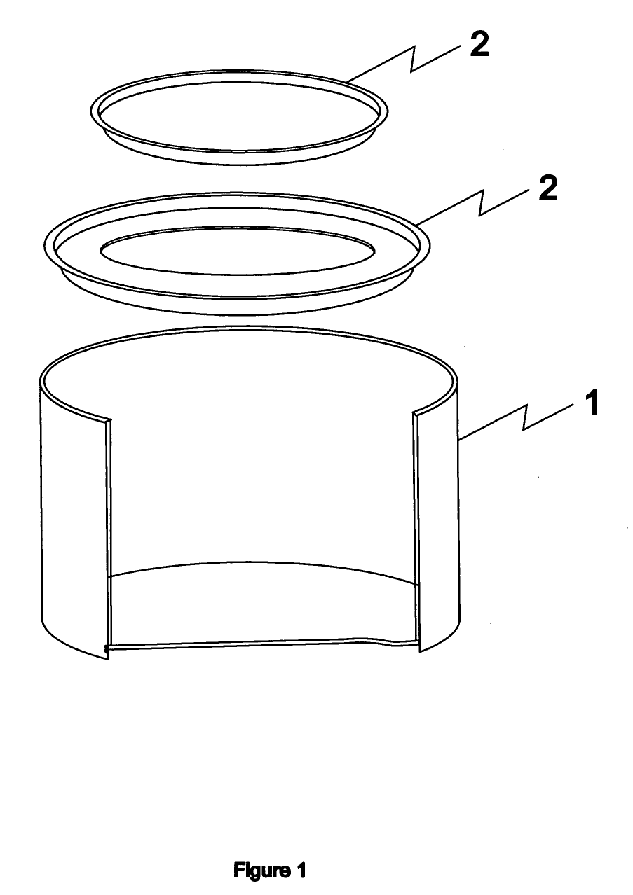

In FIG. 1, a typical can for a canned heat product is shown with a top that helps regulate the exposed surface and thus the amount of combustion 2. The lid, in the succeeding figures shown only as the larger of the rings, is attached to a base with a top and bottom 1.

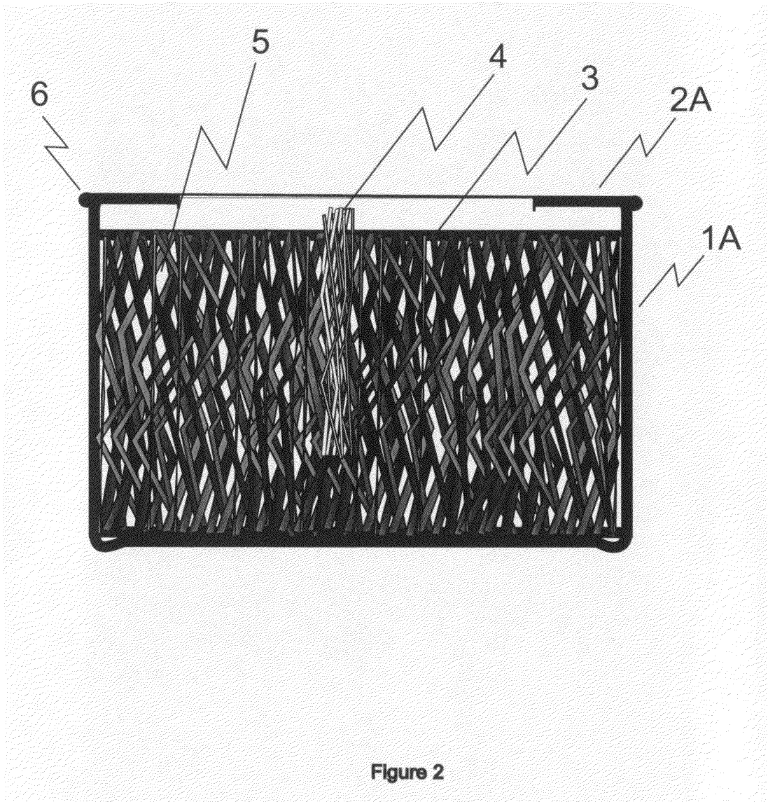

In FIG. 2, a canned heat product is shown with the addition of a fibrous fill 3, a starting wick 4, and filled with a combustible fluid 5. The top ring 2A is attached to the can bottom 1A by a rolled joint 6.

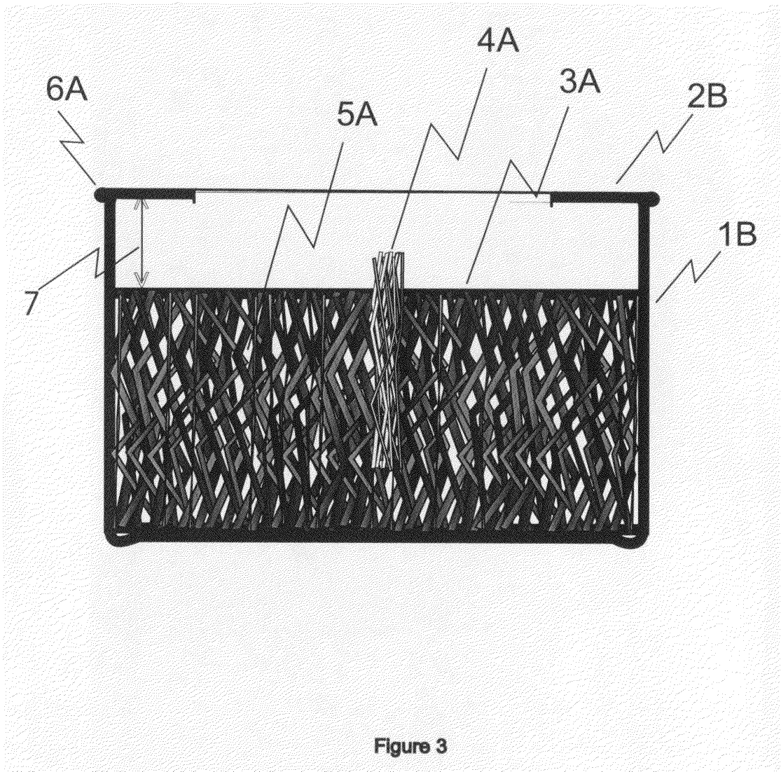

In FIG. 3, the invention is shown with the can bottom 1B affixed by rolled joint 6A to the ring top 2B and with a gap 7 formed by a deliberately lowered fibrous fill 5A and again filled with a combustible fluid 3A. The wick remains as in the previous drawing as 4A.

In FIG. 4 a typical currently produced canned heat product is shown in use with the can 1C joined at 6B to the ring top 2C. The Gap 7A is shown indicating the un-lowered fibrous fill level and the burnable fluid fill is shown by 3B. Air flow arrows 9 have been added to show air deflected by rising gas away from the surface and forming a candle like flame front caused by a conical zone of burning above the fill layer.

In FIG. 5, a can similar to that in FIG. 4 is shown in use with the can 1D joined at 6C to the ring top 2D. The Gap 7B is shown indicating the deliberately lowered fibrous fill 5C, the wick 4C and the combustible fluid fill shown by 3C. Air flow arrows 9A have been added to show air pulled into the can within the gap created by the lowering of the fill an amount 7B and the intermixing over the fiber surface causing an upwelling of air 9A and gasified burnable fluid 3C to create a hot plug like flame front 8A.

In FIG. 6 the canned heat product in FIG. 5 is shown in use with the can 1E joined at 6D to the ring top 2E. The Gap 7C is shown indicating the deliberately lowered fibrous fill 5D, the wick 4D and the burnable fluid fill shown by 3D. Air flow arrows 9B have been added to show air pulled into the can within the gap created by the lowering of the fill an amount 7C In excess of that in this invention and the result of both a lowered and less efficient flame front nearly into the can 8B and the air 9B pulled into and allowing burning at nearly the ring level with the flame front shown by 8B. An additional turbulance 10 is shown in the flow due to greater amounts of air pulled into the can causing an upwelling of flame and a flame front nearly in the can and top ring reducing heat output and causing fill problems.

### PREFERRED EMBODIMENT

In the most preferred embodiment an aluminum or steel can, 1, is taken prior to the addition of the can top 2. A plug 3 is formed from one or more fibrous bundles of a fiber glass tow (a continuous band of fibers). The tow bands are selected to give a suitable density for the fill in this application and typically is 6-8 lbs per cubic foot. The fiber bundles are lightly compressed and cut to length, the number of fibers per bundle and the fiber size determining the uncompressed density. The plug height, the distance from the bottom of the can to the top edge of the can is measured and this distance less the amount of metal used to roll on the can top plus 12 inch is determined. A plug from a batten or tow of glass fiber is then taken of a diameter to fill the can with the plug height as determined above. This plug is lightly pressed until the bottom of the plug uniformly touches the bottom of the can resulting in a can with a fiber fill that fills the bottom portion of the can to within a bit more than ½ inch from the top. The can is then filled, typically with a diethylene glycol or other spill resistant combustible fluid and the top is rolled onto the open can. The top 2B consists of an annular ring with a removable central portion and the annulus at the top downward to the fiber fill (distance 7) creates an internal combustion chamber of this invention. A wick 4 may be inserted into the fiber plug at any time in the production process but is not essential. FIG. 3 shown the basic invention as compared to the normal canned heat product in FIG. 2.

In a second embodiment the plug length is extended from the prior embodiment to ¼ inch from the top of the can, shaow as distance 7 in FIG. 3 and all other steps remain the same except for the precombustion chamber height being reduced. The invention continues to be effective but the advantage of the precombustion chamber is greatly reduced.

In a third embodiment the plug length is reduced to ¾ inch from the top of the can as shaow by 7 in FIG. 3 and all other steps remain the same except for the precombustion chamber height being reduced. The invention continues to be effective but the advantage of the precombustion chamber is, like in embodiment 2, greatly reduced.

In a fourth embodiment, the fiber fill shown as 3 in the can is an open cell silica foam briquette with a circular dimension to fill the diameter of the can and a height calculated so that the substantially flat top of the briquette is ½ inch below the top of the can.

In a fifth embodiment the plug of fiber 3 is dimensioned to fit the can within the height specified in the first three embodiments is selected from a group consisting of ceramic fibers, fiberglass, mineral wool, ceramic felt, glass fiber mat, carbon fibers, fireclay. Fire brick, chamotte, silica or magnesium oxide.

In a sixth embodiment the can is a 3 to 3 ¾ inch diameter can with a height of approximately 2 ½ to 3 ¾ inch height.

In a seventh embodiment the can is over 4½ inches in diameter, 3 to 4¾ inches high and has a ¾ inch deep precombustion chamber or a precombustion chamber proportional in depth to the diameter in the preceding examples.

In an eighth embodiment the combustible fluid 5 is selected from a group consisting of diethylene glycol, ethylene glycol, propylene glycol, ethanol, methanol, vegetable oils, stearates, parafins, and mixtures thereof.

I claim:

1. A canned heat product consisting of a combustible fuel added to a fibrous plug which has a diameter, a top and a bottom within a can which has a second diameter, a second top and a second bottom inserted within said can where said bottom of plug is in contact with the second bottom of can and where said top of plug is between ¼ inch to ¾ inch from second top of can.

2. The canned heat product in claim 1 where the fibrous plug is fiberglass

3. The canned heat product in claim 1 where the fibrous plug is rockwool.

4. The canned heat product in claim 1 where the fibrous plug is open pore ceramic foam or sponge.

5. The canned heat product where the combustible fuel is a glycol.

6. A canned heat product where a precombustion chamber is created by depressing the fibrous fill by at least ¼ inch but not more than ¾ inch to form an air flow inducing structure which improves the combustion efficiency of said canned heat product.

7. The canned heat product in claim 6 where the precombustion chamber depression is caused by cutting the fibrous fill to reduce its height within the can by ¼ to ¾ inches.
